(19) United States
(12) Patent Application Publication
(10) Pub. No.: US 2026/0310679 A1
(43) Pub. Date: Oct. 8, 2026

(54) CONVERTING DATA FORMATS USING GRAPH ANALYSIS

(71) Applicant: International Business Machines Corporation, Armonk, NY (US)

(72) Inventors: Chu Yun Tong, Beijing (CN); Wen Wen Guo, Beijing (CN); Xiao Chen Huang, Beijing (CN); Mai Zeng, Beijing (CN); Peng Hui Jiang, Beijing (CN)

(21) Appl. No.: 19/173,107

(22) Filed: Apr. 8, 2025

(51) Int. Cl. G06F 16/25; G06F 16/28

(52) U.S. Cl. CPC G06F 16/258; G06F 16/288

(57) ABSTRACT

A computer-implemented method is presented. A processor set receives a source dataset with a first data format and a destination dataset with a second data format. The processor set determines whether the first data format and the second data format are the same data format. In response to determining that the first data format and the second data format are different data formats, the processor set converts the source dataset to a number of records to be stored in a data structure within a database. The processor set generates a graph based on the number of records stored in the database. The processor set extracts relationships and dependencies between nodes in the graph to generate a number of configurations for the number of records. The processor set converts the source dataset and the destination dataset to the common data format based on the number of configurations.

### BACKGROUND

The disclosure relates generally to converting data formats using graph analysis.

An active-active architecture refers to a design where multiple nodes, servers, or data centers are actively processing requests and workloads simultaneously. Unlike traditional setups where only one node is active at a time, active-active architecture ensures that all components are fully operational and contribute to handling the workload at any given time. In other words, active-active architecture helps maximize uptime, optimize resource usage, and improve system performance.

In active-active architecture, model synchronization ensures consistency across multiple systems that are actively handling requests and workloads simultaneously. Synchronizing models involve maintaining the same version of a computational model across multiple nodes in a computer system and ensuring a consistent state when interacting with distributed systems. This feature is particularly important in machine learning or real-time systems where models need to operate seamlessly.

### SUMMARY

According to one illustrative embodiment, a computer-implemented method is provided. A processor set receives a source dataset with a first data format and a destination dataset with a second data format. The processor set determines whether the first data format and the second data format are the same data format. In response to determining that the first data format and the second data format are different data formats, the processor set converts the source dataset with the first data format to a number of records to be stored in a data structure within a database. The processor set generates a graph based on the number of records stored in the database. Each node in the graph represents a record from the number of records and each edge in the graph represents a relationship between records from the number of records. The processor set extracts relationships and dependencies between nodes in the graph to generate a number of configurations for the number of records. The number of configurations comprise representations for difference between the first data format and the second data format and rules for converting the source dataset and the destination dataset to a common data format. The processor set converts the source dataset with the first data format and the destination dataset with the second data format to the common data format based on the number of configurations. According to other illustrative embodiments, a computer system, and a computer program product are also provided.

### BRIEF DESCRIPTION OF THE DRAWINGS

FIG. 1 is a pictorial representation of a computing environment in which illustrative embodiments may be implemented;

FIG. 2 is an illustration of a block diagram of a data management environment in accordance with an illustrative embodiment;

FIG. 3 is an illustration of a conversion of data with the same data format in accordance with an illustrative embodiment;

FIG. 4 is a flowchart of a process for standardizing data formats for different datasets in accordance with an illustrative embodiment;

FIG. 5 is a flowchart of a process for extracting relationships and dependencies between nodes in the graph in accordance with an illustrative embodiment; and

FIG. 6 is a block diagram of a data processing system in accordance with an illustrative embodiment.

### DETAILED DESCRIPTION

A computer implemented method is provided. A processor set receives a source dataset with a first data format and a destination dataset with a second data format. The processor set determines whether the first data format and the second data format are the same data format. In response to determining that the first data format and the second data format are different data formats, the processor set converts the source dataset with the first data format to a number of records to be stored in a data structure within a database. The processor set generates a graph based on the number of records stored in the database. Each node in the graph represents a record from the number of records and each edge in the graph represents a relationship between records from the number of records. The processor set extracts relationships and dependencies between nodes in the graph to generate a number of configurations for the number of records. The number of configurations comprise representations for differences between the first data format and the second data format and rules for converting the source dataset and the destination dataset to a common data format. The processor set converts the source dataset with the first data format and the destination dataset with the second data format to the common data format based on the number of configurations. As a result, the illustrative embodiments provide a technical effect of efficiently standardizing data formats across different datasets using intermediate graph representations.

In the illustrative embodiments, the source dataset comprises data that are self-contained. As a result, the illustrative embodiments provide a technical effect of providing compatibility and seamless adaptability across different systems and applications.

In the illustrative embodiments, in response to determining that the first data format and the second data format are the same data format, the processor set standardizes schema for the source dataset and schema for the destination dataset such that data for the source dataset and the destination dataset follow the same structure and format. As a result, the illustrative embodiments provide a technical effect of ensuring uniformity in data structure and reducing compatibility issues as well as enabling data integration across different systems. In this example, the standardization of schema for different datasets allows efficient indexing and query optimization by maintaining a predictable structure.

In the illustrative embodiments, as part of extracting relationships and dependencies between nodes in the graph to generate a number of configurations for the number of records, the processor set analyzes nodes and edges on the graph to identify a number of distinct relationships between nodes in the graph. The number of distinct relationships are relationships that are not represented by the edges on the graph. The processor set updates the database using the number of distinct relationships. The processor set generates the number of configurations based on the number of distinct relationships. As a result, the illustrative embodiments provide a technical effect of identifying hidden patterns and relationships between nodes in a graph such that configurations such as rules for data conversions can efficiently account for differences between different data formats.

In the illustrative embodiments, the number of records are stored in a cache table within the database. As a result, the illustrative embodiments provide a technical effect of reducing query latency and lowering database workloads for performing data conversion tasks.

In the illustrative embodiments, the graph is generated based on a subset of records from the number of records, and the subset of records from the number of records are associated with format conversion between the first data format and the second data format. As a result, the illustrative embodiments provide a technical effect of efficiently using relevant data records to generate intermediate graph representations that reflect format differences between different data formats.

In the illustrative embodiments, the number of records are stored in a table for an SQL database. As a result, the illustrative embodiments provide a technical effect of providing efficient organization, retrieval, and analysis for data that can be used for generating graphs and visual representations.

A computer system comprises a processor set, a set of one or more computer-readable storage media, and program instructions, stored in the set of one or more computer-readable storage media, to cause the processor set to perform the following computer operations. The processor set receives a source dataset with a first data format and a destination dataset with a second data format. The processor set determines whether the first data format and the second data format are the same data format. In response to determining that the first data format and the second data format are different data formats, the processor set converts the source dataset with the first data format to a number of records to be stored in a data structure within a database. The processor set generates a graph based on the number of records stored in the database. Each node in the graph represents a record from the number of records and each edge in the graph represents a relationship between records from the number of records. The processor set extracts relationships and dependencies between nodes in the graph to generate a number of configurations for the number of records. The number of configurations comprise representations for differences between the first data format and the second data format and rules for converting the source dataset and the destination dataset to a common data format. The processor set converts the source dataset with the first data format and the destination dataset with the second data format to the common data format based on the number of configurations. As a result, the illustrative embodiments provide a technical effect of efficiently standardizing data formats across different datasets using intermediate graph representations.

In the illustrative embodiments, the source dataset comprises data that are self-contained. As a result, the illustrative embodiments provide a technical effect of providing compatibility and seamless adaptability across different systems and applications.

In the illustrative embodiments, in response to determining that the first data format and the second data format are the same data format, the processor set further executes the program instructions to standardize schema for the source dataset and schema for the destination dataset such that data for the source dataset and the destination dataset follow the same structure and format. As a result, the illustrative embodiments provide a technical effect of ensuring uniformity in data structure and reducing compatibility issues as well as enabling data integration across different systems. In this example, the standardization of schema for different datasets allows efficient indexing and query optimization by maintaining a predictable structure.

In the illustrative embodiments, as part of extracting relationships and dependencies between nodes in the graph to generate a number of configurations for the number of records, the processor set further executes the program instructions to analyze nodes and edges on the graph to identify a number of distinct relationships between nodes in the graph. The number of distinct relationships are relationships that are not represented by the edges on the graph. The processor set further executes the program instructions to update the database using the number of distinct relationships. The processor set further executes the program instructions to generate the number of configurations based on the number of distinct relationships. As a result, the illustrative embodiments provide a technical effect of identifying hidden patterns and relationships between nodes in a graph such that configurations such as rules for data conversions can efficiently account for differences between different data formats.

In the illustrative embodiments, the number of records are stored in a cache table within the database. As a result, the illustrative embodiments provide a technical effect of reducing query latency and lowering database workloads for performing data conversion tasks.

In the illustrative embodiments, the graph is generated based on a subset of records from the number of records, and the subset of records from the number of records are associated with format conversion between the first data format and the second data format. As a result, the illustrative embodiments provide a technical effect of efficiently using relevant data records to generate intermediate graph representation that reflects format difference between different data formats.

In the illustrative embodiments, the number of records are stored in a table for an SQL database. As a result, the illustrative embodiments provide a technical effect of providing efficient organization, retrieval, and analysis for data that can be used for generating graphs and visual representations.

In the illustrative embodiments, a computer program product is provided. The computer program product comprises a set of one or more computer-readable storage media and program instructions, stored in the set of one or more computer-readable storage media, for causing a processor set to perform the following computer operations. The program instructions are executable by the computer system to cause the computer system to receive a source dataset with a first data format and a destination dataset with a second data format. The program instructions are executable by the computer system to determine whether the first data format and the second data format are the same data format. In response to determining that the first data format and the second data format are different data formats, the program instructions are executable by the computer system to cause the computer system to convert the source dataset with the first data format to a number of records to be stored in a data structure within a database. The program instructions are executable by the computer system to cause the computer system to generate a graph based on the number of records stored in the database. Each node in the graph represents a record from the number of records and each edge in the graph represents a relationship between records from the number of records. The program instructions are executable by the computer system to cause the computer system to extract relationships and dependencies between nodes in the graph to generate a number of configurations for the number of records. The number of configurations comprise representations for differences between the first data format and the second data format and rules for converting the source dataset and the destination dataset to a common data format. The program instructions are executable by the computer system to cause the computer system to convert the source dataset with the first data format and the destination dataset with the second data format to the common data format based on the number of configurations. As a result, the illustrative embodiments provide a technical effect of efficiently standardizing data format across different datasets using intermediate graph representations.

In the illustrative embodiments, the source dataset comprises data that are self-contained. As a result, the illustrative embodiments provide a technical effect of providing compatibility and seamless adaptability across different systems and applications.

In the illustrative embodiments, in response to determining that the first data format and the second data format are the same data format, the program instructions are executable by the computer system to cause the computer system to standardize schema for the source dataset and schema for the destination dataset such that data for the source dataset and the destination dataset follow the same structure and format. As a result, the illustrative embodiments provide a technical effect of ensuring uniformity in data structure and reducing compatibility issues as well as enabling data integration across different systems. In this example, the standardization of schema for different datasets allows efficient indexing and query optimization by maintaining a predictable structure.

In the illustrative embodiments, as part of extracting relationships and dependencies between nodes in the graph to generate a number of configurations for the number of records, the program instructions are executable by the computer system to cause the computer system to analyze nodes and edges on the graph to identify a number of distinct relationships between nodes in the graph. The number of distinct relationships are relationships that are not represented by the edges on the graph. The program instructions are executable by the computer system to cause the computer system to update the database using the number of distinct relationships. The program instructions are executable by the computer system to cause the computer system to generate the number of configurations based on the number of distinct relationships. As a result, the illustrative embodiments provide a technical effect of identifying hidden patterns and relationships between nodes in a graph such that configurations such as rules for data conversions can efficiently account for differences between different data formats.

In the illustrative embodiments, the number of records are stored in a cache table within the database. As a result, the illustrative embodiments provide a technical effect of reducing query latency and lowering database workloads for performing data conversion tasks.

In the illustrative embodiments, the graph is generated based on a subset of records from the number of records, and the subset of records from the number of records are associated with format conversion between the first data format and the second data format. As a result, the illustrative embodiments provide a technical effect of efficiently using relevant data records to generate immediate graph representations that reflect format differences between different data formats.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one or more storage media (also called “mediums”) collectively included in a set of one or more storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer-readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation, or garbage collection, but this does not render the storage device as transitory because the data is not transitory while it is stored.

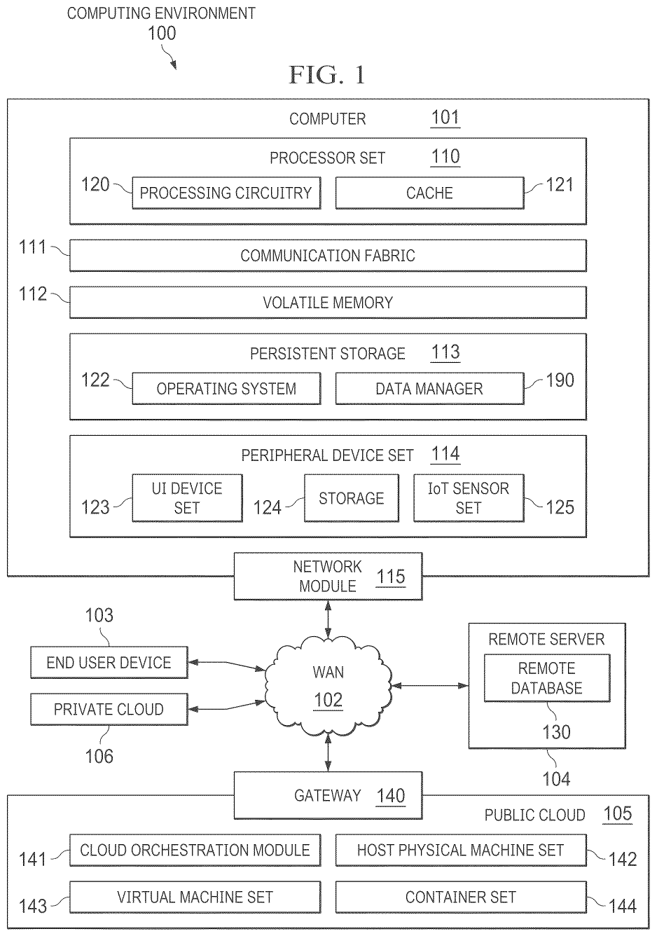

With reference now to the figures, and in particular with reference to FIG. 1, a block diagram of a computing environment is depicted in accordance with an illustrative embodiment. Computing environment 100 contains an example of an environment for the execution of at least some of the computer code involved in performing the inventive methods, such as data manager 190. In addition to data manager 190, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and data manager 190, as identified above), peripheral device set 114 (including user interface (UI) device set 123, storage 124, and Internet of Things (IOT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network, or querying a database such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one or more computer processors of any type now known or to be developed in the future. Processing circuitry 120 may be distributed over multiple packages, for example, multiple coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer-readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer-readable program instructions are stored in various types of computer-readable storage media, such as cache 121 and the other storage media discussed below. The program instructions and associated data are accessed by processor set 110 to control and direct performance of the inventive methods. In computing environment 100, at least some of the instructions for performing the inventive methods may be stored in data manager 190 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, volatile memory 112 is located in a single package and is internal to computer 101, but, alternatively or additionally, volatile memory 112 may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data, and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in data manager 190 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer-readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers, and edge servers.

END USER DEVICE (EUD) 103 is any computer system that is used and controlled by an end user (for example, a customer of an enterprise that operates computer 101) and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as a thin client, heavy client, mainframe computer, desktop computer, and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data application portability between the multiple constituent clouds. In this embodiment, public cloud 105 and private cloud 106 are both part of a larger hybrid cloud.

CLOUD COMPUTING SERVICES AND/OR MICROSERVICES: Public cloud 105 and private cloud 106 are programmed and configured to deliver cloud computing services and/or microservices (not separately shown in FIG. 1). Unless otherwise indicated, the word “microservices” shall be interpreted as inclusive of larger “services” regardless of size. Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some embodiments, cloud services may be configured and orchestrated according to an “as a service” technology paradigm where something is being presented to an internal or external customer in the form of a cloud computing service. As-a-Service offerings typically provide endpoints with which various customers interface. These endpoints are typically based on a set of APIs. One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (Saas) where software is centrally hosted and allocated on a subscription basis. SaaS is also known as on-demand software, web-based software, or web-hosted software. Four technological sub-fields involved in cloud services are: deployment, integration, on demand, and virtual private networks.

The illustrative embodiments recognize and take into account one or more different considerations as described herein. For example, the illustrative embodiments recognize and take into account that a common data format needs to be defined to be the intermediate data which could be used for data transforming and discovering for data format conversion.

The illustrative embodiments also recognize and take into account that the data format conversions require discovery of intrinsic relationship between different data formats, which can be efficiently performed using graph and relational database. In addition, the illustrative embodiments also recognize and take into account that standardizing data formats improves interoperability, data quality, processing efficiency, and automation of computer systems.

Thus, illustrative embodiments of the present invention provide a computer implemented method, computer system, and computer program product. A processor set receives a source dataset with a first data format and a destination dataset with a second data format. The processor set determines whether the first data format and the second data format are the same data format. In response to determining that the first data format and the second data format are different data formats, the processor set converts the source dataset with the first data format to a number of records to be stored in a data structure within a database. The processor set generates a graph based on the number of records stored in the database. Each node in the graph represents a record from the number of records and each edge in the graph represents a relationship between records from the number of records. The processor set extracts relationships and dependencies between nodes in the graph to generate a number of configurations for the number of records. The number of configurations comprise representations for differences between the first data format and the second data format and rules for converting the source dataset and the destination dataset to a common data format. The processor set converts the source dataset with the first data format and the destination dataset with the second data format to the common data format based on the number of configurations.

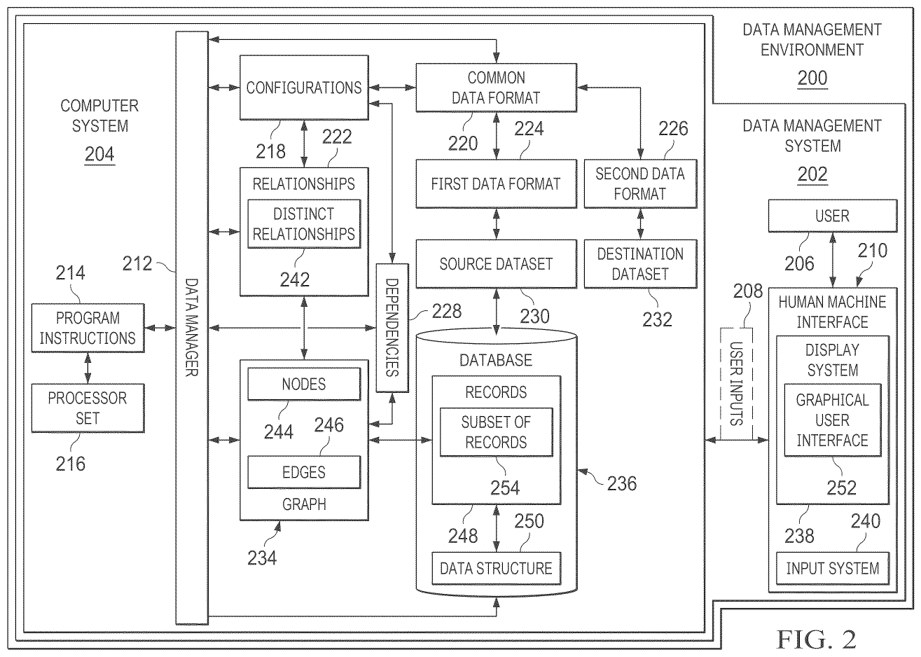

With reference now to FIG. 2, an illustration of a block diagram of a data management environment is depicted in accordance with an illustrative embodiment. In this illustrative example, data management environment 200 includes components that can be implemented in hardware such as the hardware shown in computing environment 100 in FIG. 1.

In this illustrative example, data management system 202 in data management environment 200 can be used to generate common data format 220 for standardizing first data format 224 for source dataset 230 and second data format 226 for destination dataset 232. In this illustrative example, data management system 202 includes computer system 204 which includes data manager 212. Data manager 212 is located in computer system 204. Data manager 212 may be implemented using data manager 190 in FIG. 1.

Data manager 212 can be implemented in software, hardware, firmware, or a combination thereof. When software is used, the operations performed by data manager 212 can be implemented in program instructions configured to run on hardware, such as a processor unit. When firmware is used, the operations performed by data manager 212 can be implemented in program instructions and data and stored in persistent memory to run on a processor unit. When hardware is employed, the hardware can include circuits that operate to perform the operations in data manager 212.

In the illustrative examples, the hardware can take a form selected from at least one of a circuit system, an integrated circuit, an application specific integrated circuit (ASIC), a programmable logic device, or some other suitable type of hardware configured to perform a number of operations. With a programmable logic device, the device can be configured to perform the number of operations. The device can be reconfigured at a later time or can be permanently configured to perform the number of operations. Programmable logic devices include, for example, a programmable logic array, a programmable array logic, a field programmable logic array, a field programmable gate array, and other suitable hardware devices. Additionally, the processes can be implemented in organic components integrated with inorganic components and can be comprised entirely of organic components excluding a human being. For example, the processes can be implemented as circuits in organic semiconductors.

As used herein, “a number of” when used with reference to items, means one or more items. For example, “a number of operations” is one or more operations.

Further, the phrase “at least one of,” when used with a list of items, means different combinations of one or more of the listed items can be used, and only one of each item in the list may be needed. In other words, “at least one of” means any combination of items and number of items may be used from the list, but not all of the items in the list are required. The item can be a particular object, a thing, or a category.

For example, without limitation, “at least one of item A, item B, or item C,” may include item A, item A and item B, or item B. This example also may include item A, item B, and item C, or item B and item C. Of course, any combination of these items can be present. In some illustrative examples, “at least one of” can be, for example, without limitation, two of item A; one of item B; and ten of item C; four of item B and seven of item C; or other suitable combinations.

Computer system 204 is a physical hardware system and includes one or more data processing systems. When more than one data processing system is present in computer system 204, those data processing systems are in communication with each other using a communications medium. The communications medium can be a network. The data processing systems can be selected from at least one of a computer, a server computer, a tablet computer, or some other suitable data processing system.

As depicted, computer system 204 includes processor set 216 that is capable of executing program instructions 214 and implementing processes in the illustrative examples. In other words, program instructions 214 are computer-readable program instructions.

As used herein, a processor unit in processor set 216 is a hardware device and is comprised of hardware circuits such as those on an integrated circuit that respond to and process instructions and program code that operate a computer. A processor unit can be implemented using processor set 110 in FIG. 1. When processor set 216 executes program instructions 214 for a process, processor set 216 can be one or more processor units that are in the same computer or in different computers. In other words, the process can be distributed between processor set 216 on the same or different computers in computer system 204.

Further, processor set 216 can be of the same type or different types of processor units. For example, processor set 216 can be selected from at least one of a single core processor, a dual-core processor, a multi-processor core, a general-purpose central processing unit (CPU), a graphics processing unit (GPU), a digital signal processor (DSP), or some other type of processor unit.

As depicted, computer system 204 includes source dataset 230 and destination dataset 232 that are involved in data format conversion tasks. In this illustrative example, source dataset 230 has first data format 224 and destination dataset 232 has second data format 226. First data format 224 and second data format 226 define the way data from source dataset 230 and destination dataset 232 is structured, encoded, and stored in computer system 204 to enable efficient processing, storage, and exchange. In this illustrative example, first data format 224 and second data format 226 structured data formats, semi-structured data formats, binary data formats, unstructured data formats, or any suitable data formats. In an alternative illustrative example, source dataset 230 and destination dataset 232 can include data that are self-contained. In this example, self-contained data is data that includes all necessary information within itself such that it does not require external dependencies or references to be interpreted, processed, or used. In other words, source dataset 230 and destination dataset 232 contain self-contained data that are complete, portable, and independent, making it easier to transfer, store, or analyze without additional data sources.

In this illustrative example, data manager 212 determines whether first data format 224 for source dataset 230 is the same data format as second data format 226 for destination dataset 232. If first data format 224 and second data format 226 are the same, data manager 212 standardizes schema for first data format 224 and second data format 226 such that data for first data format 224 and second data format 226 follow the same structure and format. In this illustrative example, the standardization of schema can be achieved using a number of mapping software that converts source dataset 230 into a structure that is identical to the structure of destination dataset 232 for uniformity.

On the other hand, if first data format 224 and second data format 226 are different, data manager 212 converts source dataset 230 with first data format 224 to a number of records 248 that can be stored in database 236. In this illustrative example, database 236 can be a relational database such as SQL database that stores and organizes data in tables with predefined structures and establishes relationships between the number of records 248 using keys. In this illustrative example, records 248 can be stored in data structure 250. Data structure 250 is a format of organizing, storing, and managing data to enable efficient access and modification. In this example, data structure 250 can be a table, a cached table, an index, a tree, or any suitable data structure that can be used in a relational database.

In this illustrative example, data manager 212 generates graph 234 based on the number of records 248 stored in database 236. Graph 234 includes nodes 244 and edges 246 between nodes 244. In this illustrative example, each node in nodes 244 represents a record from the number of records 248 and each edge from edges 246 represents a relationship between records from the number of records 248. In an alternative illustrative example, data manager 212 can generate graph 234 using subset of records 254 from the number of records 248. In this example, subset of records 254 can be records that are associated with data format conversion between first data format 224 and second data format 226.

In this example, data manager 212 extracts relationships 222 and dependencies 228 between nodes 244 in graph 234. Relationships 222 are information that defines how nodes 244 are connected and influence each other. In a similar fashion, dependencies 228 are information that describes how one node's existence or state affects another in graph 234.

In this illustrative example, data manager 212 can extract relationships 222 and dependencies 228 in a number of ways. For example, data manager 212 can extract relationships 222 by analyzing nodes 244 and edges 246 to identify a number of distinct relationships 242 between nodes 244 in graph 234. In this example, the number of distinct relationships 242 between nodes 244 are relationships that are not represented by edges 246 on graph 234.

For example, in the situation where graph 234 has three different nodes that represent three different data formats and edges between the three different nodes indicate that conversions can be performed to convert the data format of the first node of the three different nodes to the second node of the three different nodes while the data format of the second node of the three different nodes can be converted to the third node of the three different nodes. In this example, data manager 212 can extract the implicit relationship between the first node and the third node because the first data format represented by the first node can be converted to the third data format represented by the third node through the intermediate data format represented by the second node. In other words, data manager 212 can identify relationships between nodes 244 that are not explicitly defined by edges 246.

In this illustrative example, data manager 212 can update the number of records 248 in database 236 using distinct relationships 242 by modifying data entries from the number of records 248. For example, data manager 212 can update the number of records 248 in database 236 by adding a column to reflect distinct relationships 242.

In this example, data manager 212 uses relationships 222 and dependencies 228 to generate a number of configurations 218 that include representations for differences between first data format 224 and second data format 226 and rules for converting source dataset 230 with first data format 224 and destination dataset 232 with second data format 226 to a common data format such as common data format 220.

As a result, data manager 212 converts source dataset 230 with first data format 224 and destination dataset 232 with second data format 226 to common data format 220 based on the number of configurations 218. In this illustrative example, it should be understood that common data format 220 can also be second data format 226. In other words, data manager 212 can standardize source dataset 230 with first data format 224 and destination dataset 232 with second data format 226 using a third data format or directly converting source dataset 230 with first data format 224 to second data format 226.

In this illustrative example, user 206 can interact with computer system 204 through user inputs to computer system 204. For example, computer system 204 can receive user inputs 208 that initiates the standardization of data formats between source dataset 230 and destination dataset 232.

In this illustrative example, user inputs 208 can be generated by user 206 using human machine interface (HMI) 210. As depicted, human machine interface 210 includes display system 238 and input system 240. Display system 238 is a physical hardware system and includes one or more display devices on which graphical user interface 252 can be displayed. The display devices can include at least one of a light emitting diode (LED) display, an organic light emitting diode (OLED) display, a computer monitor, a projector, a flat panel display, a heads-up display (HUD), a head-mounted display (HMD), smart glasses, augmented reality glasses, or some other suitable device that can output information for the visual presentation of information.

In this example, user 206 is a person that can interact with graphical user interface 252 through user inputs 208 generated by input system 240. Input system 240 is a physical hardware system and can be selected from at least one of a mouse, a keyboard, a touch pad, a trackball, a touchscreen, a stylus, a motion sensing input device, a gesture detection device, a data glove, a cyber glove, a haptic feedback device, or some other suitable type of input device. For example, user 206 can view the number of source dataset 230, destination dataset 232, graph 234, relationships 222, configurations 218, and records 248 through graphical user interface 252.

In one illustrative example, one or more solutions are present that overcome a problem with standardizing data formats for datasets with different data formats. As a result, one or more technical solutions may provide an ability to increase efficiency and performance in computer system 204 by standardizing data formats to improve data exchange, processing, and storage efficiency.

In the illustrative example, computer system 204 can be configured to perform at least one of the steps, operations, or actions described in the different illustrative examples using software, hardware, firmware, or a combination thereof. As a result, computer system 204 operates as a special purpose computer system in which data manager 212 in computer system 204 enables standardization across datasets with different data formats in an efficient manner. In particular, data manager 212 transforms computer system 204 into a special purpose computer system as compared to currently available general computer systems that do not have data manager 212.

In the illustrative example, the use of data manager 212 in computer system 204 integrates processes into a practical application for standardization of datasets with different data formats in an efficient manner. In other words, data manager 212 in computer system 204 is directed to a practical application of processes integrated into data manager 212 in computer system 204 that supports standardization across datasets with different data formats in an efficient manner. In this illustrative example, data manager 212 can efficiently help computer system 204 to increase computer performance and avoid wasting computing resources because standardization across datasets with different data formats in an efficient manner can improve parsing, indexing, and querying of computer systems, especially in big data environments implemented with cloud technology. This advantage leads to faster data retrieval and reduced computational overheads when transforming or interpreting data. In addition, standardization of datasets with different data formats minimizes data redundancy and inconsistencies.

The illustration of data management environment 200 in FIG. 2 is not meant to imply physical or architectural limitations to the manner in which an illustrative embodiment can be implemented. Other components in addition to or in place of the ones illustrated may be used. Some components may be unnecessary. Also, the blocks are presented to illustrate some functional components. One or more of these blocks may be combined, divided, or combined and divided into different blocks when implemented in an illustrative embodiment. For example, data manager 212 can also convert destination data 232 into records to be stored in database 236 along with the number of records 248 for generating graph 234 and configurations 218.

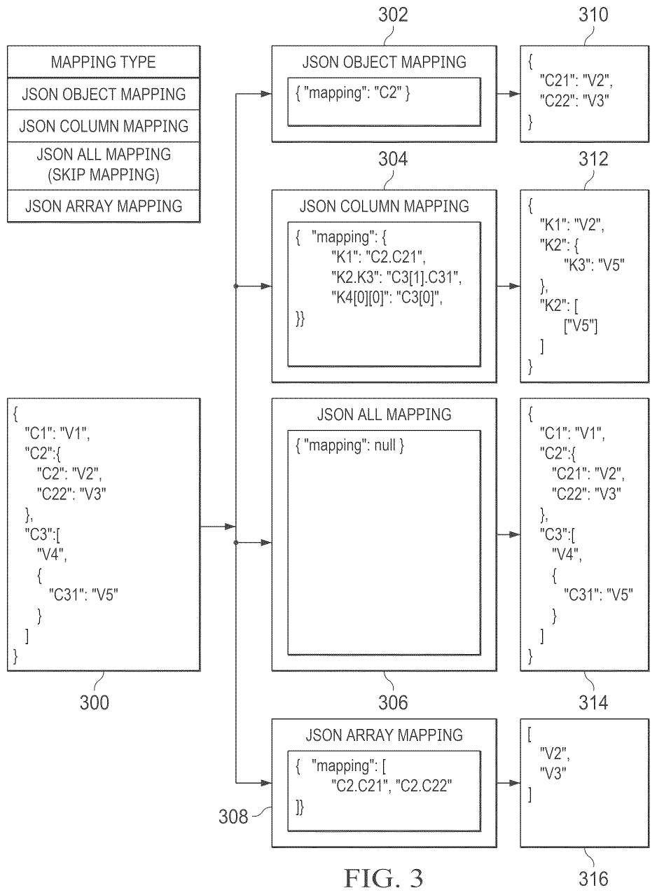

With reference now to FIG. 3, an illustration of conversion of data with the same data format is shown in accordance with an illustrative embodiment. In this illustrative example, conversion of program instruction 300 to program instruction 310, program instruction 312, program instruction 314, and program instruction 316 can be implemented using data manager 212 in FIG. 2.

In FIG. 3, program instruction 300 shows exemplary program instructions in JavaScript Object Notation (JSON) format. In this example, different elements of program instruction 300 require different mappings such that program instruction 300 can be converted to a standardized schema in accordance with requirements for other data. In other words, object, columns, and arrays of program instruction 300 in JSON format need different mapping modules for data format conversion. In this illustrative example, mapping refers to a process of applying a specific transformation, transformation rule, or data extraction operation to elements within program instruction 300.

In this illustrative example, mapping 302 shows an exemplary mapping of objects in program instruction 300 that generate program instruction 310. In addition, mapping 304 shows an exemplary mapping of columns in program instruction 300 that generate program instruction 312. Further, mapping 306 shows an exemplary mapping of all elements in program instruction 300 that generate program instruction 314. In this example, it should be understood that mapping 306 maps all values in JSON objects from program instruction 300 to “null” values to effectively clear or redact the data while maintaining the structure of program instruction 300 in JSON format. In a similar fashion, mapping 308 shows an exemplary mapping of arrays in program instruction 300 that generate program instruction 316.

The illustration of block diagrams in FIG. 3 is not meant to imply physical or architectural limitations to the manner in which an illustrative embodiment can be implemented. Other components in addition to or in place of the ones illustrated may be used. Some components may be unnecessary. Also, the blocks are presented to illustrate some functional components. One or more of these blocks may be combined, divided, or combined and divided into different blocks when implemented in an illustrative embodiment. For example, program instruction 300, program instruction 310, program instruction 312, program instruction 314, and program instruction 316 can also be represented in formats other than JSON.

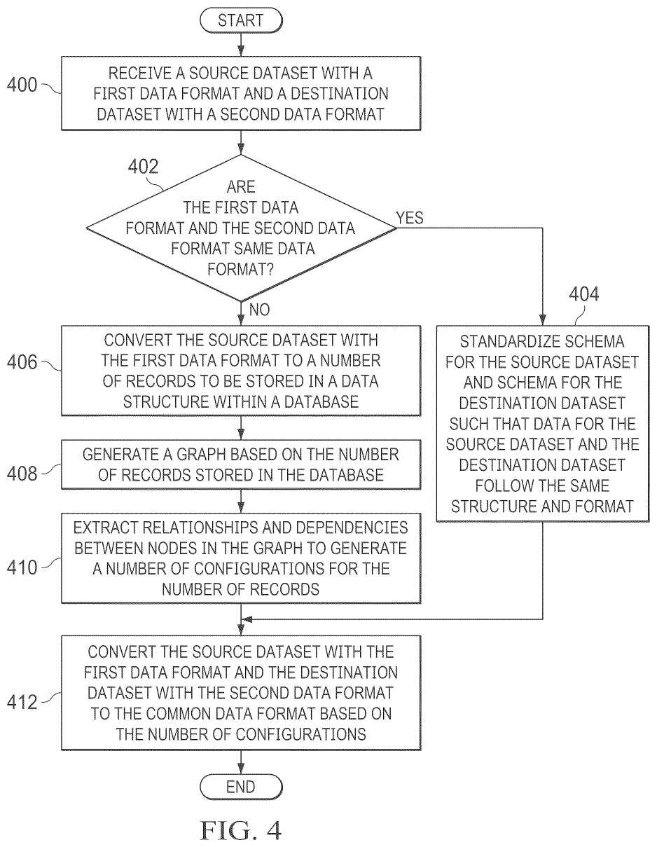

With reference now to FIG. 4, a flowchart illustrating a process for standardizing data formats for different datasets is shown in accordance with an illustrative embodiment. The process in FIG. 4 can be implemented in hardware, software, or both. When implemented in software, the process can take the form of program instructions that are run by one of more processor units located in one or more hardware devices in one or more computer systems. For example, the process can be implemented in data manager 212 in computer system 204 in FIG. 2.

The process begins by receiving a source dataset with a first data format and a destination dataset with a second data format (step 400). The process determines whether the first data format and the second data format are the same data format (step 402). In response to determining that the first data format and the second data format are the same data format, the process standardizes schema for the source dataset and schema for the destination dataset such that data for the source dataset and the destination dataset follow the same structure and format (step 404). The process terminates thereafter.

With reference again to step 402, if the first data format and the second data format are different data formats, the process converts the source dataset with the first data format to a number of records to be stored in a data structure within a database (step 406). The process generates a graph based on the number of records stored in the database (step 408). In step 408, each node in the graph represents a record from the number of records and each edge in the graph represents a relationship between records from the number of records.

The process extracts relationships and dependencies between nodes in the graph to generate a number of configurations for the number of records (step 410). In this step, the number of configurations comprise representations for differences between the first data format and the second data format and rules for converting the source dataset and the destination dataset to a common data format. The process converts the source dataset with the first data format and the destination dataset with the second data format to the common data format based on the number of configurations (step 412). The process terminates thereafter.

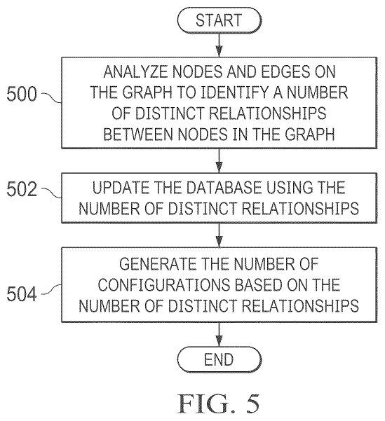

With reference now to FIG. 5, a flowchart illustrating a process for extracting relationships and dependencies between nodes in the graph is shown in accordance with an illustrative embodiment. The process in this flowchart is an example of an implementation for step 410 in FIG. 4.

The process begins by analyzing nodes and edges on the graph to identify a number of distinct relationships between nodes in the graph (step 500). In this step, the number of distinct relationships are relationships that are not represented by the edges on the graph. The process updates the database using the number of distinct relationships (step 502).

The process generates the number of configurations based on the number of distinct relationships (step 504). The process terminates thereafter.

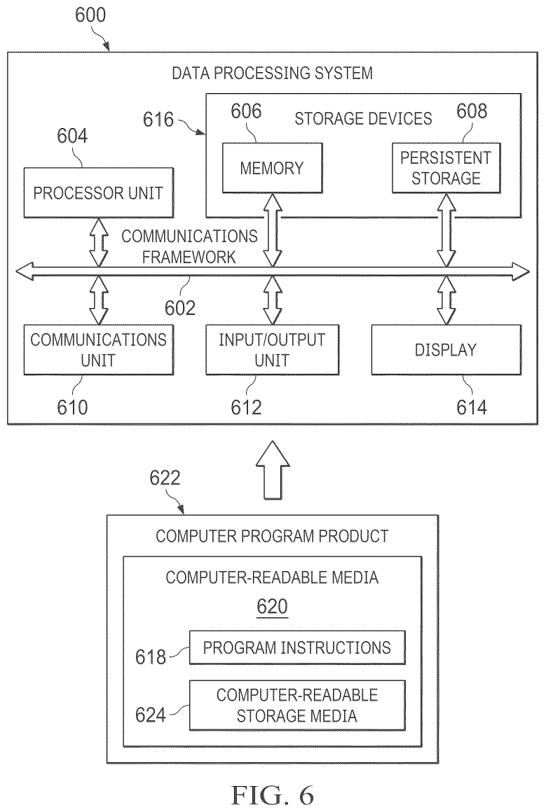

Turning now to FIG. 6, a block diagram of a data processing system is depicted in accordance with an illustrative embodiment. Data processing system 600 can be used to implement computers and computing devices in computing environment 100 in FIG. 1. Data processing system 600 can also be used to implement computer system 204 in FIG. 2. In this illustrative example, data processing system 600 includes communications framework 602, which provides communications between processor unit 604, memory 606, persistent storage 608, communications unit 610, input/output (I/O) unit 612, and display 614. In this example, communications framework 602 takes the form of a bus system.

Processor unit 604 serves to execute instructions for software that can be loaded into memory 606. Processor unit 604 includes one or more processors. For example, processor unit 604 can be selected from at least one of a multicore processor, a central processing unit (CPU), a graphics processing unit (GPU), a physics processing unit (PPU), a digital signal processor (DSP), a network processor, or some other suitable type of processor. Further, processor unit 604 can be implemented using one or more heterogeneous processor systems in which a main processor is present with secondary processors on a single chip. As another illustrative example, processor unit 604 can be a symmetric multi-processor system containing multiple processors of the same type on a single chip.

Memory 606 and persistent storage 608 are examples of storage devices 616. A storage device is any piece of hardware that is capable of storing information, such as, for example, without limitation, at least one of data, program instructions in functional form, or other suitable information either on a temporary basis, a permanent basis, or both on a temporary basis and a permanent basis. Storage devices 616 may also be referred to as computer-readable storage devices in these illustrative examples. Memory 606, in these examples, can be, for example, a random-access memory or any other suitable volatile or non-volatile storage device. Persistent storage 608 may take various forms, depending on the particular implementation.

For example, persistent storage 608 may contain one or more components or devices. For example, persistent storage 608 can be a hard drive, a solid-state drive (SSD), a flash memory, a rewritable optical disk, a rewritable magnetic tape, or some combination of the above. The media used by persistent storage 608 also can be removable. For example, a removable hard drive can be used for persistent storage 608.

Communications unit 610, in these illustrative examples, provides for communications with other data processing systems or devices. In these illustrative examples, communications unit 610 is a network interface card.

Input/output unit 612 allows for input and output of data with other devices that can be connected to data processing system 600. For example, input/output unit 612 may provide a connection for user input through at least one of a keyboard, a mouse, or some other suitable input device. Further, input/output unit 612 may send output to a printer. Display 614 provides a mechanism to display information to a user.

Instructions for at least one of the operating system, applications, or programs can be located in storage devices 616, which are in communication with processor unit 604 through communications framework 602. The processes of the different embodiments can be performed by processor unit 604 using computer-implemented instructions, which may be located in a memory, such as memory 606.

These instructions are referred to as program instructions, computer usable program instructions, or computer-readable program instructions that can be read and executed by a processor in processor unit 604. The program instructions in the different embodiments can be embodied on different physical or computer-readable storage media, such as memory 606 or persistent storage 608.

Program instructions 618 are located in a functional form on computer-readable media 620 that is selectively removable and can be loaded onto or transferred to data processing system 600 for execution by processor unit 604. Program instructions 618 and computer-readable media 620 form computer program product 622 in these illustrative examples. In the illustrative example, computer-readable media 620 is computer-readable storage media 624.

Computer-readable storage media 624 is a physical or tangible storage device used to store program instructions 618 rather than a medium that propagates or transmits program instructions 618. Computer-readable storage media 624, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Alternatively, program instructions 618 can be transferred to data processing system 600 using a computer-readable signal media. The computer-readable signal media are signals and can be, for example, a propagated data signal containing program instructions 618. For example, the computer-readable signal media can be at least one of an electromagnetic signal, an optical signal, or any other suitable type of signal. These signals can be transmitted over connections, such as wireless connections, optical fiber cable, coaxial cable, a wire, or any other suitable type of connection.

Further, as used herein, “computer-readable media 620” can be singular or plural. For example, program instructions 618 can be located in computer-readable media 620 in the form of a single storage device or system. In another example, program instructions 618 can be located in computer-readable media 620 that is distributed in multiple data processing systems. In other words, some instructions in program instructions 618 can be located in one data processing system while other instructions in program instructions 618 can be located in one data processing system. For example, a portion of program instructions 618 can be located in computer-readable media 620 in a server computer while another portion of program instructions 618 can be located in computer-readable media 620 located in a set of client computers.

The different components illustrated for data processing system 600 are not meant to provide architectural limitations to the manner in which different embodiments can be implemented. In some illustrative examples, one or more of the components may be incorporated in or otherwise form a portion of another component. For example, memory 606, or portions thereof, may be incorporated in processor unit 604 in some illustrative examples. The different illustrative embodiments can be implemented in a data processing system including components in addition to or in place of those illustrated for data processing system 600. Other components shown in FIG. 6 can be varied from the illustrative examples shown. The different embodiments can be implemented using any hardware device or system capable of running program instructions 618.

Thus, illustrative embodiments of the present disclosure provide a computer-implemented method, computer system, and computer program product for managing containers. The descriptions of the various embodiments of the present disclosure have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

The description of the different illustrative embodiments has been presented for purposes of illustration and description and is not intended to be exhaustive or limited to the embodiments in the form disclosed. The different illustrative examples describe components that perform actions or operations. In an illustrative embodiment, a component can be configured to perform the action or operation described. For example, the component can have a configuration or design for a structure that provides the component an ability to perform the action or operation that is described in the illustrative examples as being performed by the component. Further, to the extent that terms “includes”, “including”, “has”, “contains”, and variants thereof are used herein, such terms are intended to be inclusive in a manner similar to the term “comprises” as an open transition word without precluding any additional or other elements.

The descriptions of the various embodiments of the present invention have been presented for purposes of illustration but are not intended to be exhaustive or limited to the embodiments disclosed. Not all embodiments will include all of the features described in the illustrative examples. Further, different illustrative embodiments may provide different features as compared to other illustrative embodiments. Many modifications and variations will be apparent to those of ordinary skill in the art without departing from the scope and spirit of the described embodiment. The terminology used herein was chosen to best explain the principles of the embodiment, the practical application or technical improvement over technologies found in the marketplace, or to enable others of ordinary skill in the art to understand the embodiments disclosed here.

1. A method of accelerating data retrieval and reducing computational overheads, the method comprising:
receiving, by a processor set:
a source dataset with a first data format that comprises: a source structure, a source encoding, and a source storage; and
a destination dataset with a second data format that comprises: a destination structure, a destination encoding, and a destination storage;
determining, by the processor set, whether the first data format and the second data format are a same data format;
generating new data by the processor set converting, in response to determining that the first data format and the second data format are different data formats, the source dataset with the first data format to a number of records to be stored in a data structure within a database;
generating, by the processor set, additional new data comprising a graph using a subset of the number of records stored in the database, wherein each node in the graph represents a record from the subset of the number of records and each edge in the graph represents a relationship between records from the number of records;
extracting, by the processor set, relationships and dependencies between nodes in the graph, including implicit relationships that are not explicitly defined by edges, to generate a number of new data configurations for the subset of the number of records, wherein the number of new data configurations comprise representations for differences between the first data format and the second data format and rules for converting the source dataset and the destination dataset to a data format based upon the number of new data configurations, wherein the data format based upon the number of new data configurations format is represented by a node connected to a number of nodes that represent intermediate data formats for converting the first data format and the second data format to the data format based upon the number of new data configurations; and
reducing computational overheads during data transformation by improving parsing and indexing, and accelerating data retrieval by generating new data by converting, by the processor set, the source dataset with the first data format and the destination dataset with the second data format to the data format based on the number of new data configurations.

2. The method of claim 1, wherein:
the data format based upon the number of new data configurations is relational; and
the source dataset comprises data that are self-contained.

3. The method of claim 1, further comprising:
in response to determining that the first data format and the second data format are the same data format, standardizing, by the processor set, a schema for the source dataset and a schema for the destination dataset such that data for the source dataset and the destination dataset follow a same structure and format, wherein standardizing comprises at least one of applying transformations or data extractions of: elements in columns of the first data format or the second data format, or of all values in a JavaScript Object Notation format to a null value effectively clearing or redacting element values while maintaining a structure, or of arrays forming program instructions.

4. The method of claim 1, wherein extracting, by the processor set, relationships and dependencies between nodes in the graph to generate a number of configurations for the number of records comprises:
analyzing, by the processor set, nodes and edges on the graph to identify a number of distinct relationships between nodes in the graph, wherein the number of distinct relationships are relationships that are not represented by the edges on the graph;
updating, by the processor set, the database using the number of distinct relationships; and
generating, by the processor set, the number of configurations based on the number of distinct relationships.

5. The method of claim 1, wherein the number of records are stored in a cache table within the database.

6. The method of claim 1, wherein the graph is generated based on a subset of records from the number of records, and wherein the subset of records from the number of records are associated with format conversion between the first data format and the second data format.

7. The method of claim 1, wherein the number of records are stored in a table for a SQL database.

8. A computer system configured to accelerate data retrieval and reduce computational overheads, wherein the computer system comprises:
a processor set;
a set of one or more computer-readable storage media; and
program instructions stored on the set of one or more storage media to cause the processor set to perform operations comprising:
receiving, by the processor set:
a source dataset with a first data format that comprises: a source structure, a source encoding, and a source storage; and
a destination dataset with a second data format that comprises: a destination structure, a destination encoding, and a destination storage;
determining whether the first data format and the second data format are a same data format;
generating new data by the processor converting, in response to determining that the first data format and the second data format are different data formats, the source dataset with the first data format to a number of records to be stored in a data structure within a database;
generating, by the processor set, additional new data comprising a graph using a subset of the number of records stored in the database, wherein each node in the graph represents a record from the subset of the number of records and each edge in the graph represents a relationship between records from the number of records;
extracting, by the processor set, relationships and dependencies between nodes in the graph, including implicit relationships that are not explicitly defined by edges, to generate a number of new data configurations for the subset of the number of records, wherein the number of new data configurations comprise representations for differences between the first data format and the second data format and rules for converting the source dataset and the destination dataset to a data format based upon the number of new data configurations, wherein the data format based upon the number of new data configurations format is represented by a node connected to a number of nodes that represent intermediate data formats for converting the first data format and the second data format to the data format based upon the number of new data configurations; and
reducing computational overheads during data transformation by improving parsing and indexing, and accelerating data retrieval by generating new data by converting, by the processor set, the source dataset with the first data format and the destination dataset with the second data format to the data format based on the number of new data configurations.

9. The computer system of claim 8, wherein:
the data format based upon the number of new data configurations is relational; and
the source dataset comprises data that are self-contained.

10. The computer system of claim 8, wherein the operations further comprise in response to determining that the first data format and the second data format are same data format, a standardization of a schema for the source dataset and a schema for the destination dataset such that data for the source dataset and the destination dataset follow a same structure and format, wherein the standardization comprises at least one of transformations or data extractions of: elements in columns of the first data format or the second data format, or of all values in a JavaScript Object Notation format to a null value effectively clearing or redacting element values, or of arrays that form program instructions.

11. The computer system of claim 8, wherein extracting relationships and dependencies between nodes in the graph to generate a number of configurations for the number of records comprises:
analyzing nodes and edges on the graph to identify a number of distinct relationships between nodes in the graph, wherein the number of distinct relationships are relationships that are not represented by the edges on the graph;
updating the database using the number of distinct relationships; and
generating the number of configurations based on the number of distinct relationships.

12. The computer system of claim 8, wherein the number of records are stored in a cache table within the database.

13. The computer system of claim 8, wherein the graph is generated based on a subset of records from the number of records, and wherein the subset of records from the number of records are associated with format conversion between the first data format and the second data format.

14. The computer system of claim 8, wherein the number of records are stored in a table for a SQL database.

15. A computer program product configured to accelerate data retrieval and reduce computational overheads, wherein the computer program product comprises:
a set of one or more computer-readable storage media;
program instructions stored in the set of one or more computer-readable storage media to perform operations comprising:
receiving, by a processor set:
a source dataset with a first data format that comprises: a source structure, a source encoding, and a source storage; and
a destination dataset with a second data format that comprises: a destination structure, a destination encoding, and a destination storage;
determining, by the processor set, whether the first data format and the second data format are a same data format;
generating new data by the processor set converting, in response to determining that the first data format and the second data format are different data formats, the source dataset with the first data format to a number of records to be stored in a data structure within a database;
generating, by the processor set, additional new data comprising a graph using a subset of the number of records stored in the database, wherein each node in the graph represents a record from the subset of the number of records and each edge in the graph represents a relationship between records from the number of records;
extracting, by the processor set, relationships and dependencies between nodes in the graph, including implicit relationships that are not explicitly defined by edges, to generate a number of new data configurations for the subset of the number of records, wherein the number of new data configurations comprise representations for differences between the first data format and the second data format and rules for converting the source dataset and the destination dataset to a data format based upon the number of new data configurations, wherein the data format based upon the number of new data configurations format is represented by a node connected to a number of nodes that represent intermediate data formats for converting the first data format and the second data format to the data format based upon the number of new data configurations; and
reducing computational overheads during data transformation by improving parsing and indexing, and accelerating data retrieval by generating new data by converting, by the processor set, the source dataset with the first data format and the destination dataset with the second data format to the data format based on the number of new data configurations.

16. The computer program product of claim 15, wherein:
the data format based upon the number of new data configurations is relational; and
the source dataset comprises data that are self-contained.

17. The computer program product of claim 16, wherein the operations further comprise in response to determining that the first data format and the second data format are the same data format, standardizing, by the processor set, a schema for the source dataset and a schema for the destination dataset such that data for the source dataset and the destination dataset follow a same structure and format, wherein standardizing comprises at least one of transformations or data extractions of: elements in columns of the first data format or the second data format, or of all values in a JavaScript Object Notation format to a null value that effectively clears or redacts element values and maintains a structure, or of arrays that form program instructions.

18. The computer program product of claim 15, wherein extracting, by the processor set, relationships and dependencies between nodes in the graph to generate a number of configurations for the number of records comprises:
analyzing, by the processor set, nodes and edges on the graph to identify a number of distinct relationships between nodes in the graph, wherein the number of distinct relationships are relationships that are not represented by the edges on the graph;
updating, by the processor set, the database using the number of distinct relationships; and
generating, by the processor set, the number of configurations based on the number of distinct relationships.

19. The computer program product of claim 15, wherein the number of records are stored in a cache table within the database.

20. The computer program product of claim 15, wherein the graph is generated based on a subset of records from the number of records, and wherein the subset of records from the number of records are associated with format conversion between the first data format and the second data format.
